(19) United States
(12) Patent Application Publication
(10) Pub. No.: US 2005/0269463 A1
(43) Pub. Date: Dec. 8, 2005

(54) Infant feeding bottle holder

(76) Inventor: Carrie A. Hatfield, Rockwall, TX (US)

Correspondence Address: MICHAEL E. MARTIN;GARDERE WYNNE SEWELL LLP, 3000 THANKSGIVING TOWER, 1601 ELM STREET, SUITE 3000, DALLAS, TX, 75201, US

(21) Appl. No.: 10/963,900

(22) Filed: Oct. 13, 2004

Related U.S. Application Data
(63) Continuation-in-part of application No. 10/861,432, filed on Jun. 7, 2004, now abandoned.

(51) Int. Cl. A61J 9/06

(52) U.S. Cl. 248/103; 248/104; D24/199

(57) ABSTRACT

An infant feeding bottle holder comprises a rigid ring member sized to be sleeved over an infant feeding bottle and connected to opposed flexible fabric straps. Each of the straps has opposed distal end parts with cooperating hook and loop fastener members secured thereto, respectively. The strap end parts may be secured to opposed arms of a handle of an infant carrier or car seat, for example, or to any structure adjacent a resting or support place for an infant for supporting the bottle to provide for infant feeding.

### CROSS REFERENCE TO RELATED APPLICATION

This application is a continuation-in-part of copending application Ser. No. 10/861,432, filed Jun. 7, 2004.

### BACKGROUND OF THE INVENTION

Human infants normally should be fed on demand, an event which can be inconvenient for the person caring for an infant. For example, if the infant is being transported in a motor vehicle or aircraft or is otherwise accompanied by its care person away from a home environment, support for the feeding bottle can be problematic.

Accordingly, there has been a need for a feeding bottle holder of a type which may be attached to nearby support structure, which holder should be easy to fabricate, lightweight and easy to store when not in use. An example of an environment where an infant feeding bottle holder is needed is when the infant is in a portable seat or carrier, such as a so-called car seat. Another situation where an infant feeding bottle holder is desirable is when the infant is in a perambulator or baby carriage and wherein some part of the structure of such an apparatus can be used to support a feeding bottle holder.

It is to provide a solution to the above-mentioned problems in providing a suitable infant feeding bottle holder that the present invention has been developed.

### SUMMARY OF THE INVENTION

The present invention provides an improved infant feeding bottle holder which is operable to support an infant feeding bottle during feeding of the infant and when the infant is disposed in a carrier, car seat or any structure to which the holder of the invention can be connected.

In accordance with one aspect of the present invention, an infant feeding bottle holder is provided which includes a support ring which may be sleeved over an infant feeding bottle in supportive relationship thereto. The support ring is connected to a pair of opposed, elongated, flexible fabric straps, the distal ends of which are adapted to be releasably connected to nearby support structure, such as the arms of a carrier handle of an infant carrier or car seat or adjacent structure of an infant perambulator or the like.

The present invention provides an uncomplicated, easily fabricated infant feeding bottle holder which is easily adapted to support an infant feeding bottle in a position to enable the infant to feed easily and wherein the holder may be easily connected to support structure adjacent to the infant, such as the carrying handle of an infant carrier or car seat. Opposed flexible fabric straps of the holder are provided with flexible end parts which include cooperating quick release fastener means, such as hook and loop type fasteners. The feeding bottle holder of the invention may be easily stored when not in use since it is particularly compact, lightweight and otherwise unobtrusive.

Those skilled in the art will further appreciate the advantages and superior features of the feeding bottle holder of the invention described herein, together with other important aspects thereof, upon reading the detailed description which follows in conjunction with the drawing.

### BRIEF DESCRIPTION OF THE DRAWING

FIG. 1 is a perspective view of an infant feeding bottle holder in accordance with the invention; and

FIG. 2 is a view showing the feeding bottle holder connected to a carrying handle of an infant carrier or car seat and in a working position of the holder.

### DETAILED DESCRIPTION OF A PREFERRED EMBODIMENT

In the description which follows, like parts are marked throughout the specification and drawing with the same reference numerals, respectively. The drawing figures are not necessarily to scale and certain features may be shown in generalized or somewhat schematic form in the interest of clarity and conciseness.

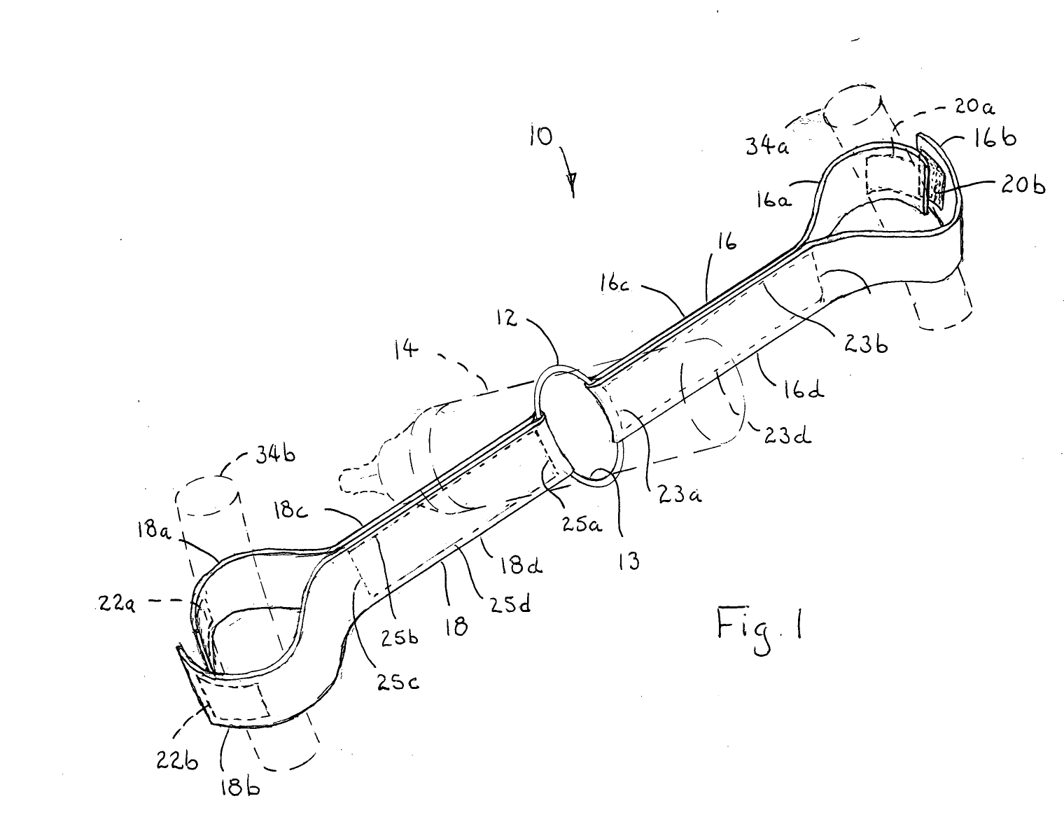

Referring to FIG. 1, there is illustrated an infant feeding bottle holder in accordance with the invention and generally designated by the numeral 10. The holder 10 includes a bottle support member, preferably comprising a substantially rigid, generally circular ring 12 of a size which may be conveniently sleeved over an infant feeding bottle 14 in supportive relationship thereto. The support ring 12 is connected to opposed, elongated, flexible, fabric support strap members 16 and 18 which are essentially identical and are each provided with opposed distal ends adapted to be releasably connected to suitable support structure, such as a carrying handle or sidewall parts of an infant carrier or so-called car seat, for example.

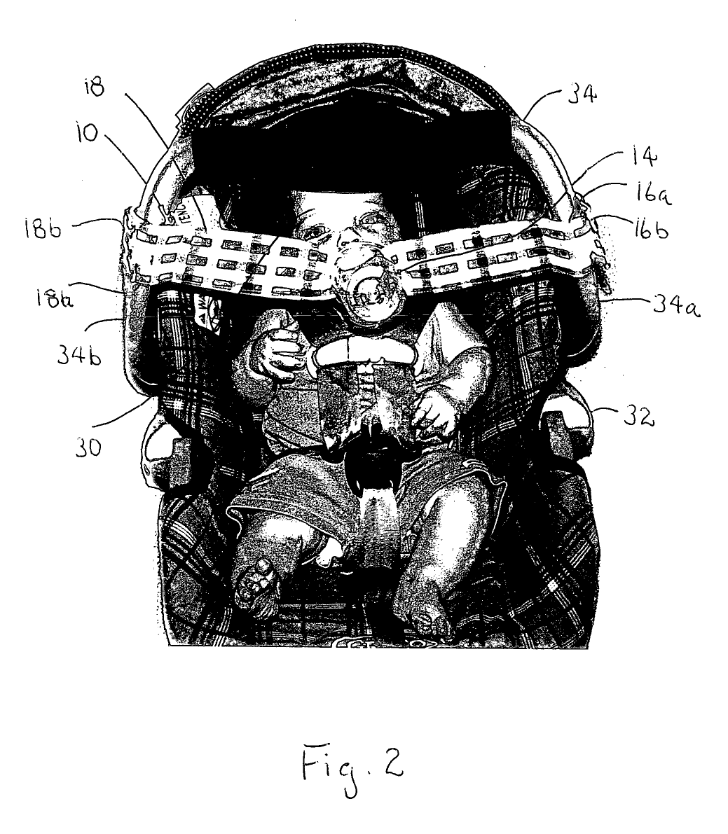

As shown in FIG. 1, each of the flexible support straps 16 and 18 is provided with flexible strap end parts. Strap 16, for example, has opposed flexible strap end parts 16a and 16b while strap 18 has corresponding flexible strap end parts 18a and 18b. Strap end part 16a is provided with a quick release fastener member 20a disposed on an outward facing surface thereof while strap end part 16b is provided with a cooperating quick release fastener member 20b disposed on an inward facing surface thereof. In like manner, strap end parts 18a and 18b are provided with corresponding quick release fastener members 22a and 22b disposed on respective outward and inward facing surfaces of such end parts, respectively. Fastener members 20a and 22a may comprise either the hook or loop portion of a hook and loop type fastener assembly and fastener members 20b and 22b may comprise the corresponding hook or loop portions of a hook and loop type fastener, all which may be of a type manufactured under the trademark Velcro. Straps 16 and 18 may be formed of any suitable fabric of natural or synthetic fibers and which may be of a colorful or aesthetically pleasing design or pattern, such as shown by way of example in the illustration of FIG. 2.

Referring again to FIG. 1, each of the straps 16 and 18 may be formed by one continuous piece of fabric which is folded over the ring 12 to form, for example, opposed strap parts 16c and 16d which may be secured together in a manner to be described in further detail herein. The outer ends of strap parts 16c and 16d also form the distal end parts 16a and 16b, respectively, as shown in FIG. 1. Strap parts 16c and 16d are preferably sewn together by stitching 23a, 23b, 23c and 23d. In like manner, strap 18 is formed by folding an elongated continuous strap part around ring 12 to form strap parts 18c and 18d which are stitched together at stitching 25a, 25b, 25c and 25d to provide the strap distal end parts 18a and 18b and to secure strap 18 to the ring 12.

As previously mentioned, a material from which straps 16 and 18 may be formed may vary widely and may be any suitable aesthetically pleasing woven fabric formed of natural or synthetic fibers. The ring 12 is preferably formed of a non-corrosive metal, such as brass, and has a diameter providing an opening 13, FIG. 1, suitable to allow the ring to be sleeved over but somewhat snugly engaged with the outer surface of an infant feeding bottle 14. The points of connection of the straps 16 and 18 to the ring 12 may assist in providing a somewhat moderate friction fit of the ring over the infant bottle. Typically, a ring 12 having a nominal diameter of about 2.50 inches is suitable. Ring 12 may be formed of non-rigid materials, if desired.

The straps 16 and 18 may each be formed by providing a strip of fabric about 22.0 inches long and about 5.0 inches wide. Fastener strips of hook and loop fastener for the fasteners 20a, 20b, 22a and 22b, may each be about 0.75 inches wide by 3.0 inches long. On the outer facing side of the aforementioned piece of fabric, the loop fastener part may be sewn in the top left corner about 1.125 inches from the edge of the 5.0 inch side and about 0.75 inches from the edge of the fabric piece with respect to the 22.0 inch side. The other fastener part of the hook and loop fastener is then sewn on the same side of the aforementioned piece of fabric in the bottom right corner also at a spacing of 1.125 inches from the 5.0 inch side of the fabric and 0.75 inches from the 22.0 inch side of the fabric. The second fastener part would be, of course, the so-called rough hook part.

The aforementioned piece of fabric may then be folded lengthwise with the outer facing side of the fabric exposed and forming a 2.50 inch wide strap. Preferably, this strap is stitched at one end and along one side to form a tube. The fabric of the open end may be tucked to form a clean edge and later top stitched. Prior to finishing any other steps for the particular piece of fabric described above, it may be pressed. The aforementioned piece of fabric may then be topstitched starting about 4.5 inches from one end, up to the end, across the end and back along its length about 4.5 inches. This may be done on both ends of each piece of fabric. The strap so formed is then folded in half over the ring 12 with the fastener parts facing each other as illustrated in FIG. 1. Each strap, after being so formed, may then be topstitched from the edge of the ring 12 4.5 inches along its length, then across the width of the strap and then back 4.5 inches to the ring to form the stitching 23a, 23b, 23c and 23d for the strap 16 and the stitching 25a, 25b, 25c and 25d for strap 18. Accordingly, the stitchings 23c and 25c define a seam from which the respective strap end parts 16a, 16b, 18a and 18b extend, respectively. The stitchings 23a and 25a also hold the straps in their proper position with respect to the ring 12 during securement of the holder 10 to a structure, such as a carrier handle of an infant carrier or car seat device.

FIG. 2 illustrates one application of the holder 10 wherein an infant feeding bottle 14 is being supported properly in relation to an infant 30 resting in an infant carrier or so-called car seat 32 having a somewhat inverted U-shaped carrying handle 34 secured thereto. Handle 34 has opposed arms 34a and 34b. Holder 10 is shown in a working position connected to the respective arms 34a and 34b wherein support strap end parts 16a and 16b are looped around the carrier handle arm 34a and their respective hook and loop fasteners secured to each other. In like manner, support strap 18 is shown with end parts 18a and 18b disposed around handle arm 34b and secured to each other by their respective fastener parts 22a and 22b.

Those skilled in the art will appreciate from the foregoing description that a convenient and advantageous infant feeding bottle holder has been provided in accordance with the present invention. Although a preferred embodiment has been described, those skilled in the art will also recognize that various substitutions and modifications may be made without departing from the scope and spirit of the appended claims.

1. An infant feeding bottle holder comprising:
a bottle support member adapted to be sleeved over an infant feeding bottle; and
a pair of opposed flexible support straps connected to said bottle support member, each of said support straps including a distal end adapted to be secured to adjacent support structure whereby said infant feeding bottle may be suspended in proximity to an infant for feeding purposes.

2. The bottle holder set forth in claim 1 wherein:
said support straps each include opposed distal strap end parts adapted to be releasably connected to each other to connect said straps to said support structure.

3. The bottle holder set forth in claim 2 wherein:
said strap end parts include cooperating fastener members secured thereto, respectively.

4. The bottle holder set forth in claim 3 wherein:
said fastener members comprise respective hook and loop fastener members, respectively.

5. The bottle holder set forth in claim 2 wherein:
said support straps are each formed by a continuous length of fabric strap part folded around a part of said bottle support member and secured to define said distal end parts, respectively.

6. An infant feeding bottle holder comprising:
a bottle support ring adapted to be sleeved over an infant feeding bottle; and
a pair of opposed flexible support straps connected to said ring, each of said straps including a distal end adapted to be secured to adjacent support structure whereby said infant feeding bottle may be suspended in proximity to an infant for feeding purposes, said straps each include opposed distal strap end parts adapted to be releasably connected to each other to connect said straps to said support structure, said strap end parts include cooperating fastener members secured thereto, respectively, said fastener members comprise respective hook and loop fastener members, respectively, and said straps are each formed by a continuous length of flexible strap part folded around said ring and secured to define said strap end parts, respectively.

7. An infant feeding bottle holder comprising:
a substantially rigid circular bottle support ring adapted to be sleeved over an infant feeding bottle; and
a pair of opposed flexible support straps connected to said ring, each of said support straps including a distal end adapted to be secured to adjacent support structure whereby said infant feeding bottle may be suspended in proximity to an infant for feeding purposes, said support straps each include opposed distal strap end parts adapted to be releasably connected to each other to secure said straps to said support structure, said strap end parts include cooperating fastener members secured thereto, respectively, said fastener members comprise respective hook and loop fastener members, respectively, and said support straps are each formed by a continuous length of flexible fabric strap part folded around said ring and secured to itself by stitching to define said strap end parts, respectively.
